(19) United States
(12) Patent Application Publication
(10) Pub. No.: US 2009/0087538 A1
(43) Pub. Date: Apr. 2, 2009

(54) Dairy Product and Process

(76) Inventor: Palatasa Havea, Palmerston North (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 12/294,039

(22) PCT Filed: Mar. 23, 2007
(86) PCT No.: PCT/NZ2007/000059

§ 371 Date: Nov. 25, 2008

(30) Foreign Application Priority Data
Mar. 23, 2006 (NZ) 546105
Apr. 11, 2006 (NZ) 546529

(51) Int. Cl. A23C 21/00; A23C 21/10

(52) U.S. Cl. 426/583

(57) ABSTRACT

A dried denatured whey protein concentrate or isolate having at least 50% of the total solids as whey protein is prepared. The method uses heat-treating of whey protein in the presence of calcium.

### TECHNICAL FIELD

This invention relates to a whey protein concentrate comprising denatured whey proteins.

### BACKGROUND ART

Whey protein is a by-product of the manufacture of cheese or precipitation of casein. In addition to water, whey also contains lactose, minerals, and whey proteins. Large amounts of whey are produced during the manufacturing of cheese and other dairy products. Whey protein products such as whey protein concentrate (WPC) and whey protein isolate (WPI) are manufactured by removing much of the other components leaving the whey protein increased relative to total solids and often as the principal component. WPCs normally have a protein content of up to 85% (w/w), whereas WPIs normally have a protein content of 90% (w/w) or more. Achievement of high protein contents is made possible due to the application of established technologies such as ultrafiltration, diafiltration and ion exchange. As proteins with good nutritional value, these products are useful as food ingredients.

They are used as functional ingredients in many foods, such as processed meat, bakery and dairy products (Kinsella, J. B. & Whitehead, D. M. Proteins in Whey: chemical, physical, and functional properties. Advances in Food Nutrition Research, 33, 343-438, 1989). Whey proteins may be combined with polysaccharides for use as a gelling agent (see for example U.S. Pat. No. 6,497,915). However, commercial uses of WPCs are limited because of unpredictable variations in their functional properties, due to composition and processing inconsistencies (Xiong, Y. L., Influences of pH and ionic environment on the thermal aggregation of whey proteins. Journal of Agricultural and Food Chemistry, 40, 380-384, 1992). For many nutritional applications the effect of whey protein on the texture or rheology of the final product is useful. These applications frequently rely on the ability of WPCs to form heat-induced gels. In other applications these gelling properties are undesirable.

It is an object of the present invention to provide an improved process for preparing a whey protein concentrate with lowered gel forming ability and/or the product and/or to offer the public a useful choice.

### DISCLOSURE OF THE INVENTION

In one aspect the invention provides a method for preparing a dried modified whey protein concentrate or isolate comprising:
(a) treating an aqueous whey protein concentrate or isolate of up to 30% (w/v) total solids, preferably 8-30%, more preferably 12-30%, with (i) divalent metal hydroxide, preferably calcium hydroxide to change the pH to about 6.0 to about 8.5, preferably about 6.6 to about 8.5, more preferably 6.9-7.5; or (ii) with divalent metal ion salt and adjusting the pH to change the pH to about 6.0 to about 8.5, preferably about 6.6 to about 8.5, more preferably 6.9-7.5, wherein sufficient divalent metal ion salt is added to increase the divalent metal ion content of the whey protein concentrate or isolate either up to 3 g/kg dry solids or at least 1.1-fold if already 3 g/kg or more; and
(b) heat treating the solution obtained to greater than 70° C., preferably greater than 85° C. to denature the whey protein; and
(c) drying the heat-treated whey protein concentrate or isolate
wherein the whey protein concentrate or isolate has at least 50% (w/w) of total solids as whey protein, preferably over 50%, more preferably 50-85% protein.

A “whey protein concentrate” is a fraction of whey from which lactose has been at least partially removed to increase the protein content to at least 25% (w/w). For the present invention the whey protein concentrate has at least 50%, more preferably at least 65%, most preferably at least 75% of the total solids as whey proteins. Preferably the proportions of the whey proteins are substantially unaltered relative to the whey from which it is derived. Preferably the whey protein concentrate is a whey protein retentate. For the purposes of this specification the term “whey protein concentrate” includes whey protein isolates when the context allows.

The whey protein concentrate starting material in (a) may be prepared by ultrafiltration of a raw whey at a pH of about 4.0-6.4, preferably 4.0-6.2, more preferably pH 5.5-6.2, most preferably about pH 6. Using ultrafiltration, water, lactose and minerals are removed resulting in a retentate stream. The ultrafiltration is typically carried out at 10-50° C. At pH 6, calcium is largely retained in the protein stream. The protein concentration of the whey protein concentrate may be further increased by evaporation. Alternatively the starting material may be a reconstituted whey protein prepared from a dried whey protein concentrate.

The whey for the preparation of the whey protein concentrate is preferably acid whey or cheese whey. Acid whey has a pH of about 4.6, whereas cheese whey has a pH of about 6-6.4. The invention requires that the whey is at about pH 7 when heated. Therefore acid whey must have more alkali added to raise its pH to 7 than cheese whey. Consequently the mineral balance at this pH is routinely adjusted differently to ensure that sufficient divalent ion concentration is reached to induce the desired divalent ion-protein interactions during heating.

The term “treating with a divalent metal hydroxide” includes any treatment that both raises the pH of the whey protein concentrate and adds divalent metal ions to it. This includes direct addition of a divalent metal hydroxide or of a mixture of a divalent metal hydroxide and other hydroxides. Preferred divalent metal hydroxides include calcium hydroxide, magnesium hydroxide and zinc hydroxide.

In addition, the term includes adding a divalent metal hydroxide and other components including salts. The term further includes the addition of alkali together with a divalent metal ion salt. For example, hydroxides such as sodium and potassium hydroxides might be used together with a divalent metal ion salt such as calcium chloride.

The nature of the materials used to increase the pH and divalent metal ion concentrations are preferably varied according to the nature of the original whey, the method for preparing the whey protein concentrate, the protein content of the whey protein concentrate and the nature of the processing steps. It is preferred to add more divalent ions when the material to be heated has a high monovalent ion concentration. For example, whey protein concentrates with relatively low protein contents such as WPC35 (which has 35% of total solids as whey protein), have relatively high concentrations of monovalent ions. In addition, where protein concentration uses evaporation instead of ultrafiltration, the concentrations of monovalent ions are generally higher. Without wishing to be limited by theory, the applicant believes that when there are high concentrations of monovalent ions, additional divalent ions are needed to push the equilibrium in favour of divalent ion-protein interactions.

Preferably, the conditions used keep monovalent ions to a minimum to avoid any need for adding additional divalent ions. Addition of a divalent metal ion hydroxide is therefore preferred to adding sodium hydroxide and a divalent metal salt. Generally, the concentration of divalent metal ions in the whey protein concentrate to be heated is in the range 3000-28000 mg/kg dry protein, preferably 4000-10000 mg/kg, more preferably 4000-8500 mg/kg, most preferably 4000-6000 mg/kg dry protein. The invention works at higher calcium concentrations, as shown in Example 13, but the likely industrial concentration is in the range given herein.

Use of steam injection during the heating step is preferred. Other forms of heating that may be used include scraped surface heat exchange, ohmic heating, and plate or tubular heat exchange. The heating time varies according to the temperature used. At higher temperatures, for example 120° C., only a few minutes may be required. At 70° C., heating for a longer period may be required.

After the heating step, there is an optional cooling step. This step is mainly to recover heat for economic reasons.

A homogenisation step may be used but is optional. When the heating conditions are properly met, the heated solution should behave like thick yoghurt. This material can be pumped, and high-pressure pumps can break down the system into very fine particles. When this is the case, there is no need to use a homogeniser.

The protein stream may then be concentrated. Typically the concentration step can be done either by ultrafiltration or evaporation.

An evaporation is optional. The homogenised protein system can also be dried directly. For economic reasons, it is highly recommended to evaporate the solution prior to drying.

The drying can be any form of drying. Spray and attrition drying are currently preferred.

The heat treatment is required to be of sufficient duration to denature the majority of the whey proteins. Preferably the heat treatment is at least 70° C., more preferably at least 85° C. for up to 40 or 60 minutes. More preferably, the solution is heated at 90-120° C.

In another aspect of the invention, there is provided a process for preparing a modified whey protein concentrate comprising
(a) providing a whey protein concentrate having a pH of about 6.6 to about 8.5, preferably 6.9-7.5 and a divalent metal ion content of 3000-28000 mg/kg dry protein, preferably 4000-10000 mg/kg, more preferably 4000-8500 mg/kg, most preferably 4000-6000 mg/kg dry protein.
(b) heat treating the solution obtained to greater than 70° C., preferably greater than 85° C. to denature the protein; and
(c) drying the heat-treated whey protein concentrate
   wherein the whey protein concentrate has at least 50% (w/w) of total solids as whey protein, preferably over 50%.

The preferred whey protein concentrates and treatment conditions are as described above. The preferred divalent metal ions are calcium, magnesium and zinc. Preferably the divalent metal ions added to the starting material are primarily calcium ions.

A further aspect of the invention provides a product of a process of the invention.

The invention allows manipulation of ion-protein interactions to promote the formation of aggregates that are predominantly formed by non-covalent association on heating. This is achieved by having a sufficient amount of divalent ion-protein interactions at the time of heating.

The proportion of monovalent-protein interactions to divalent ion-protein interactions is dynamic and the equilibrium is determined to some extent by the concentration of monovalent ions and divalent ions that are present.

If there is an insufficient concentration of divalent ion relative to monovalent ions then there will be increased disulphide bond formation.

To manufacture the preferred product of this invention when there is an insufficient concentration of divalent ions then it is necessary to add additional divalent ions to the system.

The addition of divalent ions drives the equilibrium in favour of a system where divalent ion-protein interactions are likely to occur.

Conversely if monovalent ions are added to the system then the equilibrium is driven to promoting monovalent ion-protein interactions.

The skilled worker will appreciate that there will always be a proportion of monovalent ion-protein interactions and a proportion of divalent ion-protein interactions.

An advantage of the products of the process of the invention is ease of particle size customisation prior to drying as a result of there being predominantly hydrophobic bonds in aggregates.

Compared to disulphide associated WPCs, non-covalently linked denatured WPC associations can readily be broken by mechanical shear post heating and prior to drying.

Therefore the particle size of the non-dried heat treated WPC stream of this invention can be customised by unit operations that create shear such as homogenisers, high shear pumps and by manipulation of spray drying conditions (for example atomisation means (disc verses nozzle), nozzle type, and pressure).

The median particle size of the reconstituted denatured WPC product is typically more than 10 microns and less than 70 microns.

Manipulation of particle size is important to broadening the applications in which the final product can be used. In the prior art mechanical milling post drying is commonly used if a small particle size is desired.

It is believed that the divalent ion that is used to promote the non-covalent linkages in the heat induced formation of aggregates will be locked into the modified WPC particle.

If a proportion of the divalent ions are in the form of ferrous ions then the Fe in the dried product will be locked in such a way that it will not be organoleptically detectable or able to interact with other chemical species in food systems. Iron fortification is a common problem in many foods—for example iron is known to bind with anthocyanin in strawberries changing the colour from red to grey. By fortifying foods with iron locked in the WPC produced by this invention, reactive species in food systems are protected from iron. Iron fortification of WPC can be achieved by including ferrous ions in the WPC mixture before the heating step.

The products of the invention have a wide range of utilities. These can be used in applications to increase protein content but without major changes in the texture. For example the WPCs of the invention are suitable for use in processed cheese and whey crisps (WO06/019320). The WPCs of the invention are useful in bakery applications. If a baker decided to add 6% whey protein to produce a protein rich bread, the bread would be rock hard. The present whey protein concentrate allows incorporation of the whey protein into the bread without producing such undesirable hardness.

The content of divalent metal ions useful in the invention can also be measured in mmole/kg dry solids. In these units, useful ranges include 80-220 mmole/kg dry solids, preferably 100-220 mmole/kg, more preferably 140-210 mmole/kg, most preferably 160-200 mmole/kg.

The invention consists in the foregoing and also envisages constructions of which the following gives examples only.

### BRIEF DESCRIPTION OF THE DRAWINGS

FIG. 1 is a flow chart of a process of the invention.

FIG. 2 shows the SEC profiles of 1% WPC solutions prepared from un-heated control standard cheese WPC (A392) and Modified WPC powders.

FIG. 3 is a graph of stress (), firmness (▪) and melt (▴) versus levels of Modified WPC in the processed cheese formulation.

FIG. 4 shows the effect of calcium on cheese WPC heat-induced gels: Controls with no added calcium are shown (, ◯) and samples with 847 mg Ca⁺ per kg protein (▾), 2000 mg/kg protein (∇) and 5000 mg/kg protein (▪).

FIG. 5 shows the effect of Magnesium on cheese WPC heat induced gels—no added Mg²⁺ (), and added Mg²⁺ 2000 mg/kg protein (◯) and 5000 mg/kg protein (▾).

FIG. 6 shows the effect of different divalent cations on acid WPC heat induced gels. The control is shown () and samples with added Mg²⁺ (◯ 8000 mg/kg protein), Ca²⁺ (▾ 16000 mg/kg protein) and Fe²⁺ (∇ 16000 mg/kg protein).

FIG. 7 shows the effect of added Ca²⁺ on the texture of heat induced acid WPC heat induced gels (◯ no added calcium, □ 1000 mg Ca/kg protein, Δ 2000 mg Ca/kg protein, ∇ 3000 mg Ca/kg protein, ⋄ 4000 mg Ca/kg protein, hexagons 5000 mg Ca/kg protein hexagons with cross 8000 mg Ca/kg protein.

### EXAMPLES

The following examples further illustrate practice of the invention.

### Example 1

### Manufacture of Modified WPC80

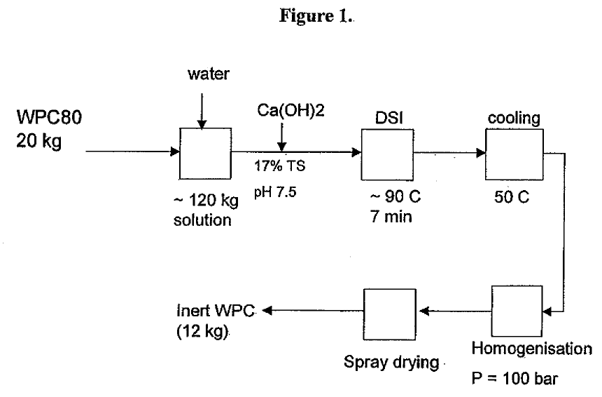

Modified WPC powder was prepared following the process depicted in FIG. 1. WPC solution (17%, w/w) was prepared from standard commercial cheese WPC80 powder (A392 Fonterra Cooperative Group Limited, Clandeboye), by reconstituting an appropriate amount of powder in miliQ water. The final solution had a pH of 6.8. The solution was neutralised using 2% Ca(OH)₂ solution. The final pH was 7.45. The solution was then heated by direct steam injection (DSI) to 90° C. for 7 min. This was achieved by circulating the heated solution in a holding tube. The solution was then cooled to about 60° C., via tubular heat exchanger, homogenised (100 bar), and then spray dried. The powder was then characterised and applied in process cheese application.

The total protein content of the WPC powders was determined using the Kjeldahl method as described by the Association of Official Analytical Chemists. Official Methods of Analysis, 14^{th} edn; Williams, S., Ed.; AOAC: Washington, D.C., 1984, with a nitrogen conversion factor of 6.38. The fat content was determined using the Soxhlet extraction method as described by Russell, C. E.; Matthews, M. E.; Gray, 1. K. A comparison of methods for the extraction of the fat from soluble whey protein concentrate powders. New Zealand Journal of Dairy Science and Technology, 15, 239-244, 1980. The moisture content was determined by oven drying pre-weighed duplicate samples at 105° C. for 24 h, cooling in a desiccator for 2 h, and reweighing the samples. The mineral analyses were carried out using inductively coupled argon-plasma emission spectrometry using the method described by Lee, J.; Sedcole, J. R.; Pritchard, M. W. Matrix interactions in an inductively coupled argon plasma optimised for simultaneous multi-element analysis by atomic emission spectrometry. Spectrochim. Acta 41B, 217-225, 1986.

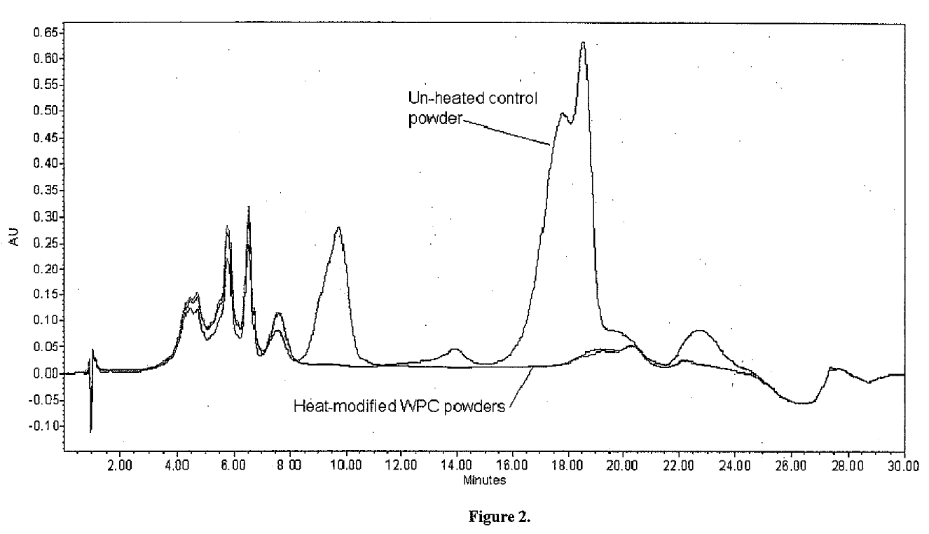

The determination of the degree of protein denaturation was carried out using size exclusion chromatography (SEC) method described by Havea, P., Singh, H., and Creamer, L. K. Heat-induced aggregation of whey proteins: Comparison of cheese WPC with Acid WPC and relevance of mineral composition. Journal of Agricultural and Food Chemistry, 50, 4674-4681, 2002. The SEC elusion profile of the 1% WPC solution prepared from Modified WPC powders were compared with that of 1% WPC solution prepared from control un-heated standard cheese WPC powder (A392). The differences between the peak areas of each protein in these samples were used to calculate the level of protein-denaturation in each powder. An example of the HPLC profiles of the control WPC and Modified WPC is depicted in FIG. 2.

The particle size distribution of the powders and that of WPC suspensions were carried out using the method described by Ye, A. and Singh, H. Influence of calcium chloride addition on the properties of emulsions stabilized by whey protein concentrate. Food Hydrocolloids, 14,337-346, 2000.

The powder was characterised alongside A392 powder for comparison. See Table 1.

TABLE 1
Composition of Modified WPC.

| Component | A392 | Modified WPC |
|---|---|---|
| Protein (%) | 80.45 | 81.1 |
| Moisture (%) | 4.56 | 3.76 |
| Fat (%) | 5.86 | 5.22 |
| Ash (%) | 2.75 | 2.36 |
| Lactose (%) | 6.55 | 6.37 |
| Ca (mg/kg) | 3200 | 3851 |
| Mg (mg/kg) | 460 | 520 |
| K (mg/kg) | 4460 | 3987 |
| Na (mg/kg) | 3720 | 3888 |
| Properties | | |
| Denaturation level | ~3% | >94% |
| Particle sizes (micro-m) | | |
| d (0.1) | 52.97 | 11.94 |
| d (0.5) | 152.89 | 30.98 |
| d (0.9) | 294.65 | 72.62 |
| D [4,3] | 164.87 | 39.72 |
| D [3,2] | 67.84 | 20.61 |

A392 was used for making the Modified WPC. The Modified WPC had very similar composition to that of the A392. The Modified WPC powder had slightly higher calcium content and smaller particle sizes. The higher calcium was due to the use of Ca(OH)₂ in pH adjustment. The Modified WPC powder was described to be bright white in colour with fine feel on fingers, and having good organoleptic qualities. This example demonstrates that using the method depicted in FIG. 1 we can manufacture denatured WPC with good qualities.

### Example 2

### Application of Modified WPC in Retort Conditions

WPC solutions (pH 7.5) were prepared by reconstitution of three different WPC powders in water: A392, Simplesse 100, a commercial denatured WPC and Modified WPC disclosed in Example 1, so that the protein content in each solution was 8% w/w. The solutions were placed in retortable glass containers and then retorted at 121° C. for 10 min. The solutions were then assessed visually for the presence of gel and or precipitates.

When proteins are used at high levels (e.g. >5%) in retorted beverages, it is desirable that these proteins remain in suspension during the retorting process.

After the solutions were retorted, A392 and Simplesse 100 WPC solutions had formed large masses of protein gels. The Modified WPC solution had fine particles of protein precipitates. However, the protein content remained largely in suspension. This demonstrates that the Modified WPC of this invention can be used in retorted beverages. One skilled in the art would understand that heat treatment of native whey protein, especially at this level, will result in gel formation. This result also demonstrates that Modified WPC of this invention has sufficient degree of denaturation that the suspension remained after retorting (i.e. lack the ability to form heat-induced gels).

### Example 3

### Application of Modified WPC in Model Processed Cheese Slice System

The Modified WPC, disclosed in Example 1, was used in a processed cheese formulation where a total protein of 10% was used. The control runs contained rennet casein only. The other sets of samples had 20% of the total protein replaced by either the Modified WPC or the standard cheese WPC (A392). The results are shown in Table 2.

TABLE 2
Properties of processed cheese slices where Modified WPC was
used - results are average of 5 different samples (n = 5).

| | | Stress | | Firmness | | Moisture | | Viscosity |
|---|---|---|---|---|---|---|---|---|
| | | (Pa) | Strain | (g) | Melt | (%) | pH | Pa · s |
| A392 | AVE | 11861 | 0.78 | 8.70 | 3.71 | 46.18 | 5.56 | 1471 |
| | STDEV | 208 | 0.04 | 0.74 | 0.55 | 0.12 | | 150 |
| Modified WPC | AVE | 12484 | 0.81 | 9.85 | 7.83 | 46.82 | 5.64 | 1355 |
| | STDEV | 425 | 0.05 | 1.24 | 0.68 | 0.01 | | 185 |
| Rennet Casein | AVE | 20997 | 0.81 | 11.70 | 6.08 | 46.79 | 5.71 | 1784 |
| | STDEV | 736 | 0.04 | 0.67 | 0.62 | 0.38 | | 209 |

It should be noted that the Modified WPC offers higher melting than either the rennet casein only or the standard WPC (A392).

### Example 4

### Impact of Denatured Whey Protein on a Model Processed Cheese Slice System

Processed cheese slice samples were prepared using the formulation showed in Table 3. The protein ingredients used were rennet casein (ALAREN 799, 90 mesh), A392, and Modified WPC (disclosed in Examples 1-3).

A hybrid cheese-rennet casein formulation was used. The formulation is shown in Table 3.

TABLE 3
Processed cheese formulation

| | MATERIAL | | | | Actual | |
|---|---|---|---|---|---|---|
| INGREDIENTS | I.D. # | QUANTITY | | % | Weight | Process Notes |
| | | | kg | | | Order of addition: |
| Rennet Casein - SKL | Ex SKL | 3.340 | kg | 11.133% | | |
| ADDED WATER | | 10.780 | kg | 35.933% | | |
| TSC | lungbunzlaue | 0.720 | kg | 2.400% | | |
| Vacuum salt bulk | | 0.330 | kg | 1.100% | | |
| | | | kg | | | Times: |
| Hi solids cheddar | Ex Ng | 5.970 | kg | 19.900% | | |
| Salted Butter | spec/Visser e | 6.830 | kg | 22.767% | | |
| | | | kg | | | |
| 392 —SKL | Ex SKL | 1.060 | kg | 3.533% | | |
| HT WPC —SKL | Ex SKL | 0.260 | kg | 0.867% | | Weights: |
| LACTOSE | | 0.470 | kg | 1.567% | | |
| Citric Acid | lungbunzlaue | 0.210 | kg | 0.700% | | |
| Potassium Sorbate | | 0.030 | kg | 0.100% | | |
| | | | kg | | | |
| | | | kg | | | Viscosity: |
| | | | kg | | | pH: |
| | | | kg | | | |
| | | | kg | | | |
| | | | kg | | | |
| | | | kg | | | |
| | | | kg | | | Slice comments: |
| | | | kg | | | Peel: |
| | | | kg | | | Shine: |
| | | | kg | | | Break: |
| | | | kg | | | Pasty: |
| TOTAL (INCL. REWORK) | | 30.000 | kg | 100.00% | | |

The whey protein component of the formulation (20% of the total protein) is a mixture of Modified WPC (labeled HT-WPC in the table above) and A392. Having varying levels of each resulted in varying levels of Modified WPC in each sample. The following mixtures were used (Table 4):

TABLE 4
Levels of Modified WPC and A392 in each processed cheese sample

| Levels of | A392 | Modified WPC |
|---|---|---|
| Modified WPC (%) | (g) | (g) |
| 0 | 1.320 | 0.000 |
| 20 | 1.060 | 0.260 |
| 40 | 0.790 | 0.530 |
| 60 | 0.530 | 0.790 |
| 100 | 0.000 | 1.310 |

The cheddar cheese was a high solid cheese manufactured at Fonterra-Whareroa in 2004. It has been stored frozen for most of its life.

An RVA-4 was used to make the processed cheese (10 minute cook, maximum speed 800 rpm and maximum temperature 85° C. The molten cheese was cast into 2 mm slices and stored in a 4° C. fridge in plastic bags for 3 days before texture and melt testing. Stress and strain were measured using the Vane test (Brookfield), firmness was measured using the Cylinder test (TA-XT2) and melt was assessed using a modified melt method (170° C. for 10 minutes) of Kosikowski, F. V. and Mistry, V. V. (1997) Cheese and Fermented Milk Foods, 3^{rd} Edition, P.259. L.L.C. Connecticut.

The leftovers from testing were used to check pH and moisture. pH was measured by glass electrode and an oven method (105° C. for 16 hours) was used to measure moisture levels (Table 5).

TABLE 5
pH and moisture of processed cheese samples

| Levels of | Moisture | |
|---|---|---|
| Modified WPC (%) | (%) | pH |
| 0 | 47.1 | 5.60 |
| 20 | 47.2 | 5.62 |
| 40 | 47.3 | 5.63 |
| 60 | 47.2 | 5.63 |
| 100 | 47.3 | 5.66 |

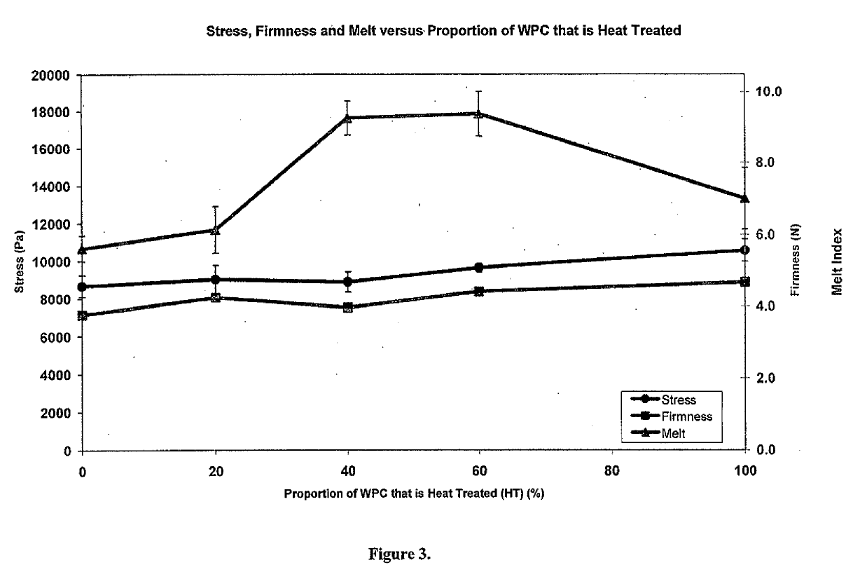

The measured properties of Texture and melt are shown in Table 6, and plotted in FIG. 3.

TABLE 6
Measured texture properties of processed cheese slices

| | Stress | | | | Firmness | | Melt | |
|---|---|---|---|---|---|---|---|---|
| Proportion of | (Pa) | | Strain | | (N) | | Index | |
| HT-WPC (%) | Mean | SD | Mean | SD | Mean | SD | Mean | SD |
| 0 | 8681 | 584 | 0.900 | 0.096 | 383 | 13 | 5.6 | 0.4 |
| 20 | 9034 | 731 | 0.895 | 0.085 | 432 | 5 | 6.1 | 0.6 |
| 40 | 8892 | 530 | 0.921 | 0.040 | 404 | 11 | 9.3 | 0.5 |
| 60 | 9628 | 215 | 0.924 | 0.030 | 449 | 12 | 9.4 | 0.6 |
| 100 | 10583 | 602 | 0.917 | 0.055 | 475 | 8 | 7.0 | 0.8 |

The stress and firmness data display similar trends—both generally increase as the proportion of denatured whey protein increases. The melt trend is less straightforward. Melt decreases in the following order: 40%, 60%>100%>20%, 0%.

### Example 5

### Evidence of the Effect of Calcium on Gel Strength of Heated WPC Solutions

A WPC solution (16% TS, ˜13% protein, pH 6.8) was prepared by dissolving appropriate amount of cheese WPC80 (A392) in water. Different aliquots of this solution were prepared and calcium (CaCl₂) was added to each at different levels. The changes in the rheological properties of the solutions during heating were monitored while being heated from 20 to 80° C. at 2° C./min and then held at 80° C. for 30 min to allow denaturation of whey proteins.

Dynamic oscillatory viscoelasticity of the solutions was monitored at low strain using a controlled stress rheometer using a cup and bob configuration. About 19 ml of WPC solution was poured into the sample cell and covered with at layer of low viscosity mineral oil to prevent evaporation. The rheological properties were determined in the linear viscoelastic region (0.5% strain) and at a constant frequency of 1 Hz

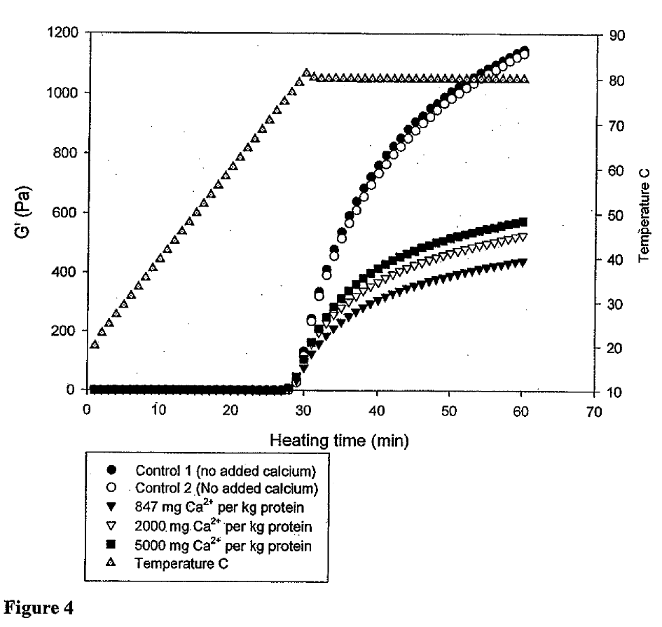

FIG. 4 demonstrates that addition of calcium from about 1000 mg per kg protein resulted in reducing the strength of the heat-induced gels by more than 50%. Having lower gel strength would allow processing such as pumping and homogenisation to take place with relative ease.

### Example 6

### Evidence of the Effect of Added Magnesium MgCl₂) on the Rheological Properties of Heat-Induced WPC Gels

A further WPC solution of the same concentration and conditions as that in Example 5 was prepared. Various levels of Mg²⁺ (MgCl₂) were added to different aliquots of the WPC solution. The changes in the rheological properties of these solutions during heating were monitored using the same method described in Example 5.

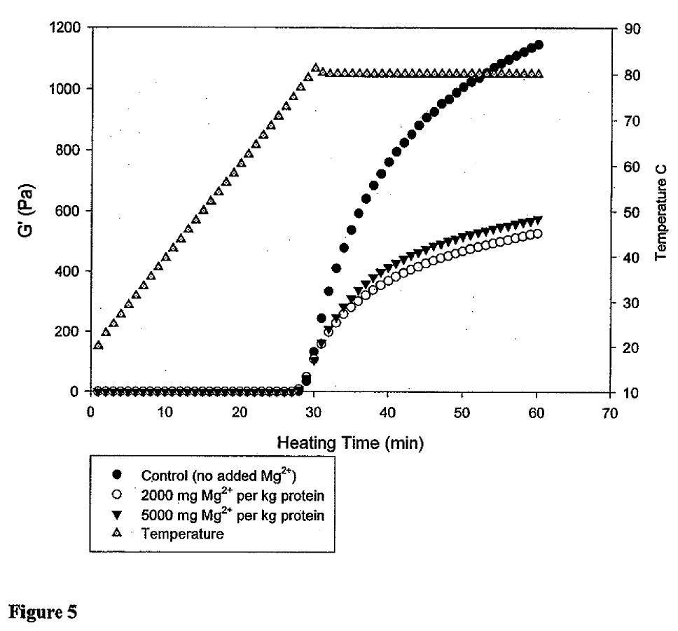

FIG. 5 demonstrates that addition of magnesium at levels of 2000 to 5000 mg per kg protein resulted in reduction of the gel strength to less than 50%. This example demonstrates that the calcium and magnesium, being both divalent cations, have similar effect on the gel strength of the WPC solution during heating.

The impact of these ions is optimal at a certain concentration. The level of addition will depend on the initial ion concentration of the protein solution to which the calcium/or magnesium is added. When the initial WPC solution was made from acid WPC, for example, the calcium content can be less than a third of what is normally present in standard cheese WPC. In this case, the added calcium should be at a sufficient level so to induce predominantly non-covalently aggregated proteins.

### Example 7

### Evidence of Different Sources of Raw Materials

A WPC solution was prepared using acid WPC80 (instead of cheese WPC) but have the same conditions as that in Example 5. Aliquots of this solution were prepared and different levels of calcium or magnesium were added. The changes in theological properties of these solutions during heating were monitored in the same way as described in Example 5.

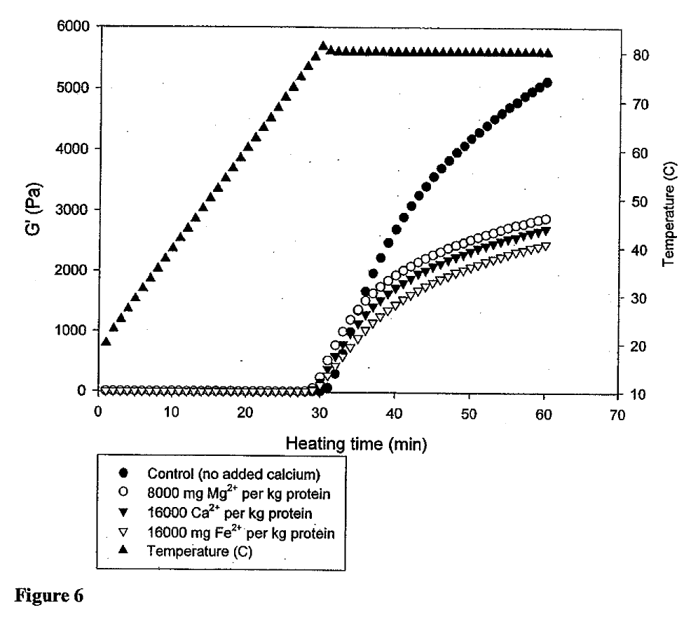

The changes in the storage modulus G′ of the WPC solutions during heating is shown in FIG. 6. It is clear that addition of calcium (CaCl₂), magnesium (MgCl₂), or iron (FeSO₄.7H₂O) at sufficient levels resulted in significant reduction in the levels of G′, >50%. One of the main differences between acid and cheese WPCs is that cheese WPC contains far more divalent cations than acid WPC (Havea P, Singh H & Creamer L K Heat-induced aggregation of whey proteins: comparison of cheese WPC with acid WPC and relevance of mineral composition. Journal of Agricultural and Food Chemistry, 50, 4674-4681, 2002). So addition of divalent cations into WPC solutions would have to be sufficient to impart changes in the nature of the denatured proteins.

### Example 8

### Effect of Added Calcium on the Texture of Acid WPC Heat-Induced Gels

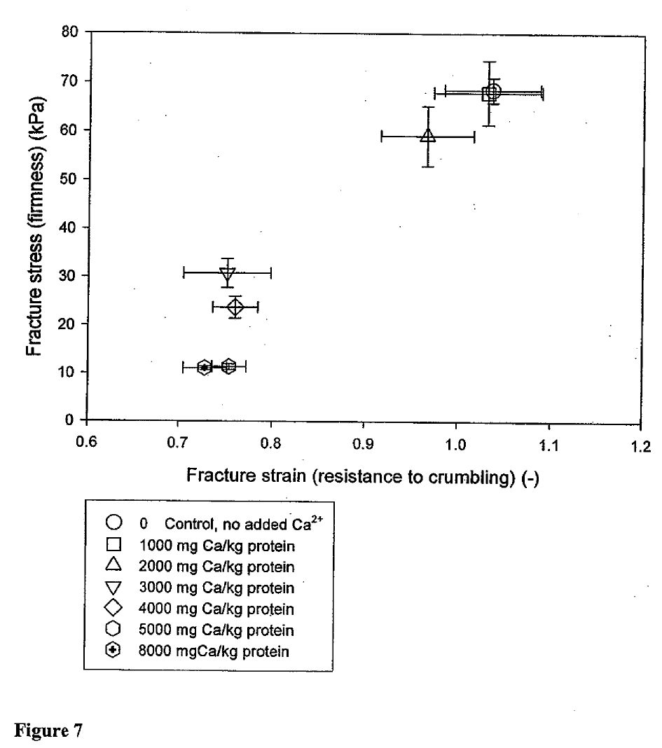

Acid WPC solutions (the same as in Example 7) prepared and calcium was added at different levels. The solutions were then placed in 400-cm-long, 30-mm-diameter, medium-walled polycellulosic plastic tubes and the ends were closed off using rubber bands to make stiff ‘sausages’. These sausages were then placed in a thermostatically controlled water bath (80° C.±0.5) for 60 min. It took approximately 40 s to heat the middle of each tube to 79.8° C. After heating, the tubes were removed from the water bath and immediately placed in an ice bath (≈0° C.) for 30 min before storing at 4° C. overnight. The gels were then cut to give four cylindrical slices, each 30 mm in length, using a wire cutter and a template. Each slice was wrapped with plastic film to prevent moisture loss, placed in a sealed container and then left in a thermostatically controlled (20° C.) test room for 2 h to equilibrate before testing. The samples were placed between the upper 60-mm-diameter Teflon plate and the lower 95 mm×105 mm Teflon plate of a TA-ID Texture Analyser (Stable Micro Systems, Haslemere, UK). The surfaces of the plates were lubricated with paraffin oil to minimize friction. The samples were then compressed to 80% of their original height at a rate of 0.83 mm so using a load cell of 500 N. The fracture stress and fracture strain were calculated for each sample using a software package based on analysis methods outlined in draft standards for a testing and analysis protocol developed by the International Dairy Federation (IDF). The results were plotted in a texture map as described by Hamann, D. D. & MacDonald, G. A., (1992). Rheology and texture properties of surimi and si-based foods. In T. C. Lanier, & C. M. Lee (Eds), Surimi technology (pp. 429-500). New York: Marcel Dekker, Inc., and Truong, V. D. & Daubert, C. R. Textural characterization of cheeses using vane rheometry and torsion analysis. Food Engineering and Physical Properties, (2001) 6, 6 716-721, in order to provide information on the gels' texture. The results are shown in FIG. 7.

The results demonstrate that as the added calcium increased from 0 to 8000 mg per kg protein the fracture stress (gel firmness) decreased by more than 80% and the fracture strain (resistance to crumbling) decreased by about 70% (the error bars represent 95% confidence interval). These changes are described as changing from strong elastic gels to “mushy” gels. Mushy gels are a soft easy to break type of gel. When the heat-induced WPC gels are changed in this way, it is easy to break up the gels by mean of pumping, homogenisation or other high shear system.

### Example 9

### Production of Heat-Modified WPC from Acid Whey

In a pilot plant trial, 7501 of whey retentate (obtained from ultra-filtration and diafiltration of lactic acid whey) was supplied by a commercial WPC plant. This retentate had 22% dry matter, 65% protein, 20% lactose, 4% fat and 3% ash (all relative to the dry matter), at pH 6.0. The retentate was then diluted with demineralised water to 1500 L. The pH of the diluted retentate was then adjusted to 7 using a 10% Ca(OH)₂. The diluted retentate was then split into 2 lots of 750 L. Each stream was processed differently as two different runs.

### Run 1

The diluted retentate was heated using an online direct steam injection (DSI) system to 65° C., and then to 120° C. for 4 min, using a second on line DSI unit. After heating, the protein solution was flash cooled to 60° C. The heated protein solution was then homogenised at 250 bar. The homogenised protein solution was then evaporated. The final evaporated concentrate had 31% dry matter. The concentrated protein solution was then spray dried to obtain a denatured WPC powder.

### Run 2

The second lot of diluted retentate was processed following the same steps as in Run 1 accept that the heating was done at 120° C. for 8 min. In addition, the evaporation step concentrated the whey protein solution to 30% dry matter.

The composition and analyses of the modified whey protein powders are shown in Table 7.

TABLE 7
Composition and analyses of heat-modified WPC powders
produced from lactic acid whey

| Component & analyses | Run 1 | Run 2 |
|---|---|---|
| Powder quantities (kg) | 67 | 53 |
| Protein (%) | 67.24 | 66.93 |
| Moisture (%) | 3.96 | 4.58 |
| Fat (%) | 3.78 | 3.29 |
| Ash (%) | 4.08 | 4.10 |
| Lactose (%) | 19.10 | 18.90 |
| Protein denaturation levels (%) | >95 | >95 |
| Particle size [4,3], (μm) | 106 | 152 |

The results demonstrate that a dried heat modified WPC product can be manufactured using acid whey as raw material. The results also demonstrate that heat treatment of the whey solution (8%) for 4 min or 8 min did not appear to make much difference in the properties of the powders. This indicates that heat treatment of the whey to achieve desirable levels of protein denaturation (e.g. 80%) may need to be held under milder conditions. The results also demonstrate that evaporation of the heated whey protein solution to high solids (˜30%) is achievable. This has significant economic benefits.

### Example 10

### Evidence of High Solids Heating

A WPC solution (4.5 L, 22.4% TS, ˜18% protein) was prepared by reconstituting appropriate amount of cheese WPC80 powder (A392) in water. After addition of 8000 mg calcium per kg protein, the pH was then adjusted to 6.7. The solution was then pre-heated in a water bath that was thermostatically kept at 65° C. via a continuous set-up. The solution was pumped using a peristalsis pump via 4 m long (inside diameter of 6 mm) stainless coil that was emerged in the water bath. After the solution was passed through the coil, the WPC solution had an average temperature of 62±1° C. The solution was then further heated using the same set-up but heating was via a thermostatically 86° C. water bath. After the solution was pumped through the coil, it had an average temperature of 79±1° C. The heated solution was collected in a stainless steel beaker and was continuously stirred using an overhead stirrer (four equal sized blades, 6 cm diameter, 180 rpm). The stainless beaker was emerged in another water bath that contained hot water (78±2° C.). The WPC solution was held at this temperature for 10 min before the beaker was emerged in cold water bath while cooling to ˜62° C. The viscosity of samples taken at various stages was then measured using a Brookfield viscometer. The results are shown in Table 8.

TABLE 8
Viscosities of heated cheese WPC solution (measuring spindle S61)

| | Temp (° C.) at | Speed | Viscosity |
|---|---|---|---|
| Sample | measurement | rpm | (cp) |
| Initial WPC solution | 20.9 | 30 | 15 |
| (after reconstitution) | 20.9 | 60 | 16 |
| After pre-heating (65° C.) | 53-52 | 60 | 9 |
| After heating (86° C.) | 57 | 12 | 95 |
| | 53 | 12 | 91 |
| Heated solution after high | 53.5 | 30 | 58 |
| shear mixing using Ultraturrax | | | |
| mixer (9500 rpm, 1 min) | | | |

The degree of denaturation in the heated solution was estimated using HPLC to be >90%.

The above results demonstrate that after at a higher TS (22.3%) or total protein content of ˜18%, it is possible to heat denature most of the protein while maintaining the heated solution at relatively low viscosity (<100 cp). At this viscosity, the heated solution can still be processed, either pumped or evaporated. The results also show that after high shear mixing (ultraturrax or homogenisation) the viscosity decreased significantly.

### Example 11

### Production of Heat-Modified WPC55 Using Reconstituted WPC55 Powder

In a pilot plant trial, commercial cheese WPC55 powder (Fonterra Cooperative Group Limited, Lichfield) was reconstituted in demineralised water so the final solution had 12% dry matter. The WPC powder contained 56.6% protein, 3.8% moisture, 4.0% fat, 3.8% ash, and 31.8% lactose. The reconstituted solution had pH 7.0. A solution of calcium chloride was then added so that a final addition rate of 1800 mg calcium per kg protein was achieved. The solution was then heated using the same system used in Example 1 at 120 for 4 min. The heated protein solution was then homogenised at 250 bars then evaporated using a falling film evaporator. The concentrated solution had 32% dry matter. The concentrate was then sprayed to obtain Modified WPC powder. The powder was analysed and the results are shown in Table 9. The powder was described to be white and having plain organoleptic properties.

TABLE 9
Analyses of heat modified WPC55

| Component & analyses | Results |
|---|---|
| Powder quantity (kg) | 42 |
| Protein (%) | 55.8 |
| Moisture (%) | 4.0 |
| Fat (%) | 3.3 |
| Ash (%) | 4.9 |
| Lactose (%) | 30.5 |
| Protein denaturation levels (%) | >95 |
| Particle size [4,3], (μm) | 104 |

### Example 12

### Production of Heat-Modified WPC55 Using Reconstituted WPC55 Powder Without the Addition of Calcium Chloride

In another pilot plant trial, a WPC solution (12% dry matter) was prepared using the same WPC55 used in Example 11 above. The solution was processed following the same procedures used in Example 11 above, except there was no calcium added. When the solution was heated, the heated solution went so tick quickly that the DSI system got blocked after 12 rain of running time, resulting in stopping of the run. The viscosity of the heated solution was beyond the limit of the Brookfield viscometer (>10⁵ cp). A few attempts were made to improve the situation but there no improvement. As a result there was no powder produced from this run.

This example demonstrates that the importance of calcium addition. In this case the protein content of the heated reconstituted WPC solution was about 7%. At this level WPC solution can form a thick gel. Such gel is formed by a combination of both disulphide linkages and non-covalent associations (Havea P., Singh H., Creamer, L. K. & Campanella, O. H. Electrophoretic characterization of the protein products formed during heat treatment of whey protein concentrate solutions. Journal of Dairy Research, 65, 79-91, 1998). In sufficient levels of salts such get would be formed under high temperature heat treatment such as in this run. The addition of calcium forces the protein-protein interactions to be predominantly non-covalent.

### Example 13

### Production of Heat-Modified WPC80

A WPC solution was prepared by reconstituting standard cheese WPC80 (50 L, 16% dry matter, ˜12.8% protein, pH 6.8) and calcium was added at 25000 mg/kg protein. The reconstituted solution was then indirectly heated at 85° C. for 4 min using a Spiroflo Tubular Heat Exchanger. The heated solution was then evaporated using a tubular falling film evaporator, to a dry matter content of around 29% and the spray dried to obtain a WPC powder. The powder was described as being plain white with good organoleptic qualities. This powder was then characterised and the composition and properties are shown in Table 10.

TABLE 10
Analyses of heat-modified WPC powder

| Component & analyses | Results |
|---|---|
| Powder quantity (kg) | 5 |
| Protein (%) | 74 |
| Moisture (%) | 4.0 |
| Fat (%) | 3.3 |
| Ash (%) | 9.1 |
| Lactose (%) | 4.0 |
| Protein denaturation levels (%) | >94 |
| Particle size [4,3], (μm) | 65 |

This example demonstrates that the product of this invention can be made using an initial protein concentration of about 13%. It is also show that at a high calcium level of 25000 mg/kg protein, the product can be produced. It also shows that in absence of homogenisation a powder of relatively fine particles can be manufactured.

The term ‘comprising’ as used in this specification means ‘consisting at least in part of’, that is to say when interpreting statements in this specification that include that term, the features, prefaced by that term in each statement are present but other features can also be present.

The above examples are illustrations of the practice of the invention. It will be appreciated by those skilled in the art that the invention can be carried out with numerous modifications and variations. For example the materials used the starting material may vary the processing times and temperatures may likewise be varied.

1. A method for preparing a dried modified whey protein concentrate or isolate comprising:
(a) treating an aqueous whey protein concentrate or isolate of up to 30% (w/v) total solids, with (i) divalent metal hydroxide to change the pH to about 6.0 to about 8.5; or (ii) with divalent metal ion salt and adjusting the pH to change the pH to about 6.0 to about 8.5 and sufficient divalent metal ion salt is added to increase the divalent metal ion content of the whey protein concentrate either up to 3 g/kg dry solids or at least 1.1-fold if already 3 g/kg; and
(b) heat treating the solution obtained to greater than 70° C. to denature the whey protein; and
(c) drying the heat-treated whey protein concentrate
wherein the whey protein concentrate or isolate has at least 50% (w/w) of total solids as whey protein.

2. A method as claimed in claim 1 wherein the initial whey protein concentrate or isolate comprises 12-30% (w/v) total solids

3. A method as claimed in claim 1 wherein the whey protein concentrate or isolate has at least 65%, the total solids as whey proteins.

4. A method as claimed in claim 1 wherein the proportions of the whey proteins are substantially unaltered relative to the whey from which the whey protein concentrate or isolate is derived.

5. A method as claimed in claim 1 wherein the initial whey protein concentrate or isolate starting material is a whey protein retentate.

6. A method as claimed in claim 5 wherein the initial whey protein concentrate or isolate starting material is prepared by ultrafiltration of a raw whey at a pH of about 4.0-6.4.

7. A method as claimed in claim 6 wherein the whey protein concentrate or isolate starting material is prepared by ultrafiltration of a raw whey at a pH of 5.5-6.2.

8. A method as claimed in claim 1 wherein the initial whey protein concentrate or isolate starting material is treated with divalent metal hydroxide.

9. A method as claimed in claim 8 wherein the initial whey protein concentrate starting material or isolate is treated with calcium hydroxide.

10. A method as claimed in claim 1 wherein the initial whey protein concentrate or isolate starting material is treated with an alkali together with a divalent metal ion salt.

11. A method as claimed in claim 1 wherein the concentration of divalent metal ions in the whey protein concentrate or isolate to be heated is in the range 3000-28000 mg/kg dry protein.

12. A method as claimed in claim 11 wherein the concentration of divalent metal ions in the whey protein concentrate or isolate to be heated is in the 4000-10000 mg/kg

13. A method as claimed in claim 1 wherein the heat treatment is carried out at least 70° C.

14. A method as claimed in claim 12 wherein the heat treatment is carried out at 90-120° C.

15. A method for preparing a modified whey protein concentrate or isolate comprising
(a) providing a whey protein concentrate or isolate in solution having a pH of about 6.6 to about 8.5, and a divalent metal ion content of 3000-28000 mg/kg dry protein,
(b) heat treating the solution obtained to greater than 70° C.; and
(c) drying the heat-treated whey protein concentrate
wherein the whey protein concentrate has at least 50% (w/w) of total solids as whey protein.

16. A method as claimed in claim 15 wherein the initial whey protein concentrate or isolate comprises 12-30% (w/v) total solids.

17. A method as claimed in claim 15 wherein the whey protein concentrate or isolate has at least 65%, the total solids as whey proteins.

18. A method as claimed in claim 15 wherein the proportions of the whey proteins are substantially unaltered relative to the whey from which the whey protein concentrate or isolate is derived.

19. A method as claimed in claim 15 wherein the initial whey protein concentrate or isolate starting material is a whey protein retentate.

20. A method as claimed in claim 19 wherein the initial whey protein concentrate or isolate starting material is prepared by ultrafiltration of a raw whey at a pH of about 4.0-6.4.

21. A method as claimed in claim 20 wherein the whey protein concentrate or isolate starting material is prepared by ultrafiltration of a raw whey at a pH of 5.5-6.2.

22. A method as claimed in claim 15 wherein the initial whey protein concentrate or isolate starting material is treated with divalent metal hydroxide.

23. A method as claimed in claim 22 wherein the initial whey protein concentrate or isolate starting material is treated with calcium hydroxide.

24. A method as claimed in claim 15 wherein the initial whey protein concentrate or isolate starting material is treated with an alkali together with a divalent metal ion salt.

25. A method as claimed in claim 15 wherein the concentration of divalent metal ions in the whey protein concentrate or isolate to be heated is in the range 3000-28000 mg/kg dry protein.

26. A method as claimed in claim 25 wherein the concentration of divalent metal ions in the whey protein concentrate or isolate to be heated is in the 4000-10000 mg/kg.

27. A method as claimed in claim 15 wherein the heat treatment is carried out at east 70° C.

28. A method as claimed in claim 27 wherein the heat treatment is carried out at 90-120° C.
